(19) United States
(12) Patent Application Publication
(10) Pub. No.: US 2007/0237345 A1
(43) Pub. Date: Oct. 11, 2007

(54) METHOD FOR REDUCING PHASE VARIATION OF SIGNALS GENERATED BY ELECTRET CONDENSER MICROPHONES

(75) Inventors: Bo Zhang, Nanjing (CN); Ming Zhang, Cupertino, CA (US); Lili Chen, Nanjing (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: FORTEMEDIA, INC., Cupertino, CA (US)

(21) Appl. No.: 11/696,308

(22) Filed: Apr. 4, 2007

Related U.S. Application Data
(60) Provisional application No. 60/789,957, filed on Apr. 6, 2006.

(51) Int. Cl. H04R 3/00; H04R 25/00

(52) U.S. Cl. 381/113; 381/174

(57) ABSTRACT

The invention provides a method for reducing phase variation of a signal generated by an electret condenser microphone. An error of a capacitance of the electret condenser microphone is reduced. An impedance of the electret condenser microphone is increased. A shunt resistance is added to the electret condenser microphone. A −3 dB cut-off frequency of the electret condenser microphone is lowered.

### BACKGROUND OF THE INVENTION

1. Field of the Invention

The invention relates to Electret Condenser Microphones (ECM), and more particularly to phase variations in signals generated by electret condenser microphones.

2. Description of the Related Art

Condenser microphones comprise a capacitor, an electronic component which stores energy in the form of an electrostatic field. A capacitor has two plates with voltage therebetween. In the condenser microphone, one plate is of very light material and acts as a diaphragm that vibrates when struck by sound waves, changing the distance between the two plates and thereby the capacitance. Specifically, when the plates are closer, capacitance increases and a charge current occurs. When the plates are further apart, capacitance decreases and a discharge current occurs. Thus, a condenser microphone converts a sound wave to a current or a voltage signal.

A electret condenser microphone uses a special type of capacitor which has a permanent voltage built in during manufacture. Like a permanent magnet, the capacitor requires no external power for operation. However, electret condenser microphones normally include a pre-amplifier which does require power.

A microphone array is a set of multiple microphones operating in tandem. A system including a microphone array can extract specific input from ambient noise. FIG. 1 is a block diagram of a system 100 extracting specific voice input from ambient noise. The system 100 includes a microphone array 102, an ADC array 104, and a digital signal processor 106. The microphone array includes multiple microphones 102A˜102N, converting a sound wave S to multiple voltage signals Xₐ˜X_{N}. Because the microphones 102A˜102N receive the sound wave S at different locations, the voltage signals Xₐ˜X_{N} have slightly different phases reflecting the phase difference of the sound wave S at different receiving locations. After the ADCs 104A˜104N convert the analog voltage signals Xₐ˜X_{N} to digital signals Y_{A}˜Y_{N}, the DSP 106 can then derive a specific voice input Z from ambient noise according to phase difference between the signals Y_{A}˜Y_{N}.

The microphones 102A˜102N of the microphone array 102 may be electret condenser microphones. If electret condenser microphones are used as the microphones 102A˜102N, the electret condenser microphones must be fabricated as equally as possible, such that the electret condenser microphones generate signals with no phase error therebetween, able to convert a sound signal to the same electric signal with identical phase. If the electret condenser microphones generate signals with considerable phase errors, the phase differences between the digital signals Y_{A}˜Y_{N} comprise the phase errors generated by the electret condenser microphones, inducing errors in the derivation of the signal Z. Thus, a method for reducing phase variation between electret condenser microphones is required.

### BRIEF SUMMARY OF THE INVENTION

The invention provides a method for reducing phase variation of a signal generated by an electret condenser microphone. A capacitance error of the electret condenser microphone is reduced. An impedance of the electret condenser microphone is increased. A shunt resistance is added to the electret condenser microphone. A -3dB cut-off frequency of the electret condenser microphone is lowered.

The invention also provides a method for reducing phase variation of a signal generated by an electret condenser microphone. An error of a thickness of a spacer of the electret condenser microphone is reduced. Phase asymmetry of the signal is reduced as the electret condenser microphone rotates about a central axis thereof. Sound sensitivity of a vent of the electret condenser microphone is reduced. The vent of the electret condenser microphone is prevented from exposure to an outer sound field.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a bock diagram of a microphone array system extracting specific input from ambient noise;

FIG. 2a is a block diagram of an electret condenser microphone;

FIG. 2b shows typical values of circuit elements of the microphone circuit and the preamplifier circuit of the electret condenser microphone in FIG. 2a;

FIG. 3 is a three-dimensional view of the internal structure of an electret condenser microphone;

FIG. 4a shows a phase response corresponding to sound with frequency range from 1 Hz to 100 kHz;

FIG. 4b shows a magnitude response corresponding to sound with frequency range from 1 Hz to 100 kHz;

FIG. 5 shows a relation between microphone capacitances corresponding to four polarization voltages and sound frequency;

FIG. 6a shows a vent opening unexposed to the outside sound field;

FIG. 6b shows a vent opening exposed to the outside sound field; and

FIG. 7 shows the phase response of electret condenser microphones with exposed vent and unexposed vent.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

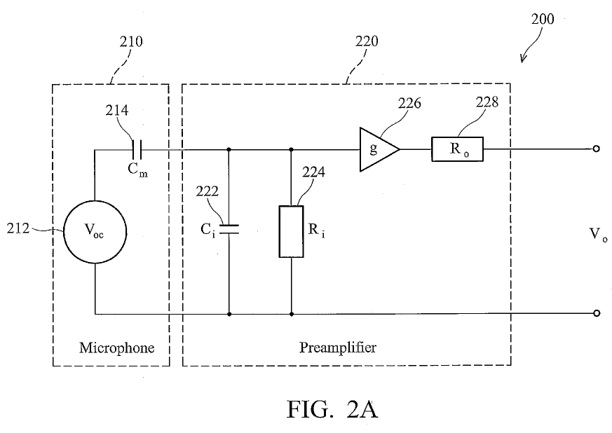

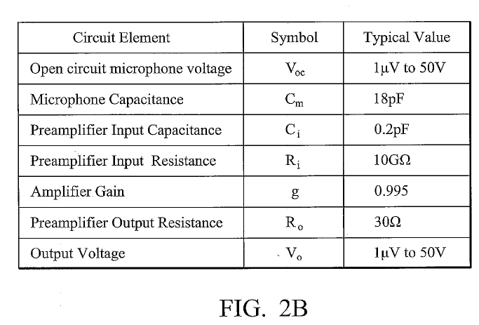

A typical electret condenser microphone includes a microphone circuit and a preamplifier circuit. FIG. 2A is a block diagram of an electret condenser microphone 300. The electret condenser microphone 300 comprises a microphone circuit 310 and a preamplifier circuit 320. The microphone circuit 300 converts a sound wave to a voltage signal V_{OC}. Because the level of the voltage signal V_{OC} is weak, the preamplifier circuit 320 amplifies the voltage signal V_{OC} to an output voltage V_{O} with a voltage level suitable for subsequent processing.

The microphone circuit 310 can be simplified as a voltage source V_{OC} and a microphone capacitance Cₘ. The preamplifier circuit 320 can be simplified as a preamplifier input capacitance Cᵢ, a preamplifier input resistance Rᵢ, an amplifier 326 with gain g, and a preamplifier output resistance Rₒ. Typical values of circuit elements of the microphone circuit 310 and the preamplifier circuit 320 are shown in the table of FIG. 2B. The electrical frequency response of the electret condenser microphone 300 is given by the following formula as a function of the circuit elements:

$$\frac{{V}_{O}}{{V}_{OC}} = \frac{{C}_{m}}{{C}_{m} + {C}_{i}} \cdot \frac{jω ( {C}_{m} + {C}_{i} ) {R}_{i}}{1 + jω ( {C}_{m} + {C}_{i} ) {R}_{i}} \cdot g \cdot \frac{1}{1 + jω {C}_{O} {R}_{O}}$$

$$G = \frac{{C}_{m}}{{C}_{m} + {C}_{i}} g$$

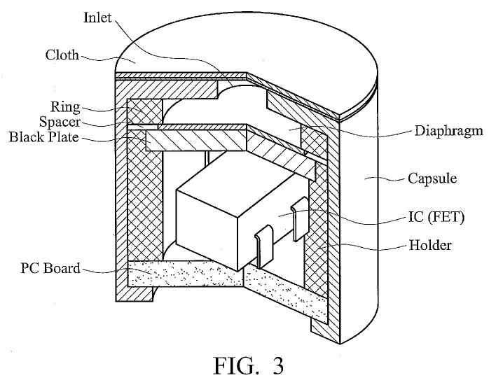

FIG. 3 is a three-dimensional view showing the internal structure of an electret condenser microphone. A sound wave of outer space enters cavity inside the capsule of the microphone through an inlet and generates pressure on a diaphragm. A spacer between the diaphragm and a back plate fastens the fringe distance therebetween, and the diaphragm and the back plate form a capacitor. When the sound wave strikes the diaphragm, the diaphragm vibrates, and the distance between the diaphragm and the back plate changes, changing the capacitance value. Change of the capacitance value produces a voltage signal altering in correspondence to the sound wave pressure. The IC lying on the PC board on the bottom of the capsule comprises an FET forming the preamplifier amplifying the voltage signal.

To reduce phase variation of signals generated by electret condenser microphones, a few factors must be considered in design of the electret condenser microphone. The invention considers ten factors concerning phase variation of the electret condenser microphone, including variation of capacitance of the whole microphone, error of the spacer, impedance of condenser, asymmetry for phase, shunt resistance, variation of microphone capacitance, vent sensitivity, low frequency phase response, polarization voltage, and vent position. The ten consideration factors are respectively described as follows.

(1) Variation of Capacitance of the Whole Microphone Module:

The capacitance of the whole electret condenser microphone affects phase shift. To reduce phase variation of a signal generated by an electret condenser microphone, the capacitance variation of the whole microphone, including errors of capacitance of microphone module 310 and the preamplifier module 320, must be controlled within a threshold. Typical error range of the capacitance value is between −5% and 5%. To reduce the phase variation of the generated signal, the error of capacitance value of the electret condenser microphone is reduced to the range between −1% and 1%.

(2) Error of the Spacer:

As shown in FIG. 3, the spacer directly controls the distance between the diaphragm and the back plate. Because the distance between the diaphragm and the back plate determines the microphone capacitance, increasing error of the spacer also increases the error of the capacitance of the electret condenser microphone and the phase variation of the signal generated by the electret condenser microphone. Thus, if the error of the thickness of the spacer is reduced, the phase variation of the signal generated by the electret condenser microphone is also reduced.

The error of the spacer is represented as the error measure E divided by the thickness T of the spacer. If the thickness of the spacer is increased, the error of the spacer can be reduced under the same error measure. Typical thickness of a spacer is 20 μm, and the error measure is ±2 μm. To reduce the phase variation of the generated signal, the thickness of the spacer of the electret condenser microphone is increased to 40 μm. Thus, the error of the spacer is reduced to 40 μm±2 μm.

(3) Impedance of the Condenser:

If the impedance of the condenser of the electret condenser microphone is not high enough, charge can leak when the diaphragm moves, resulting in poor output of the voltage generated by the electret condenser microphone with phase shift. Thus, the impedance of the condenser also affects the phase of the generated signal.

To reduce phase shift of the generated voltage, the capacitance Cₘ of microphone is reduced. Because the impedance of the condenser is proportional to the inverse of the capacitance Cₘ of the microphone, reducing the capacitance Cₘ can increase the impedance of the condenser and reduce the phase shift. Methods for reducing the capacitance Cₘ include increasing the thickness of the spacer and reducing the diameter of the diaphragm.

(4) Asymmetry for Phase:

According to empirical experiments, when one of a pair of electret condenser microphones is rotated about the central axis thereof, the phase difference between the two microphones changes with the rotated angle, because the diaphragm of the rotated microphone is not perfectly parallel to the back plate.

To improve a parallel level between the diaphragm and the back plate of an electret condenser microphone, the thickness of the spacer is increased. Because the thickness of the spacer is increased, minimal thickness error of the spacer does not negatively affect parallelity between the diaphragm and the back plate of an electret condenser microphone.

(5) Shunt Resistance:

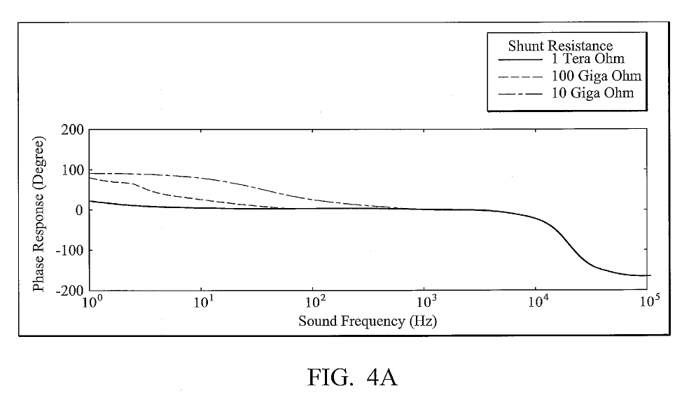

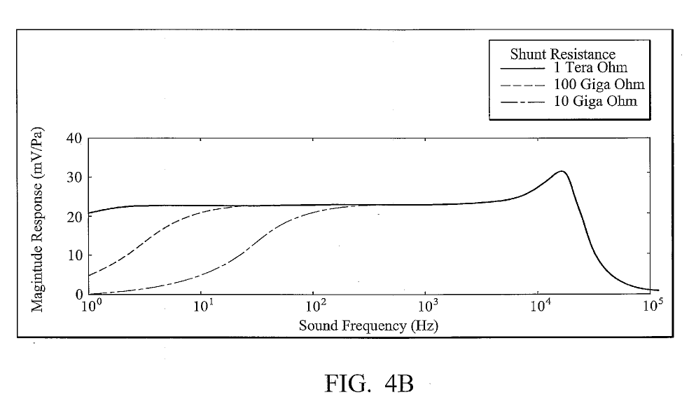

FIG. 4A and 4B respectively show phases and magnitudes of empirical frequency responses of electret condenser microphones with different shunt resistances. Three levels of shunt resistance, 10 GΩ, 100 GΩ, and IteraΩ, are coupled to the same electret condenser microphone, and the phase response to sound with frequency range from 1 Hz to 100 kHz are shown in FIG. 4A. A typical high-quality electret condenser microphone has 10 G Ω shunt resistance provided by an audio line transformer. A scientific-grade electret condenser microphone has 100 G Ω shunt resistance provided by gate impedance of an FET preamplifier attached directly to the microphone terminals.

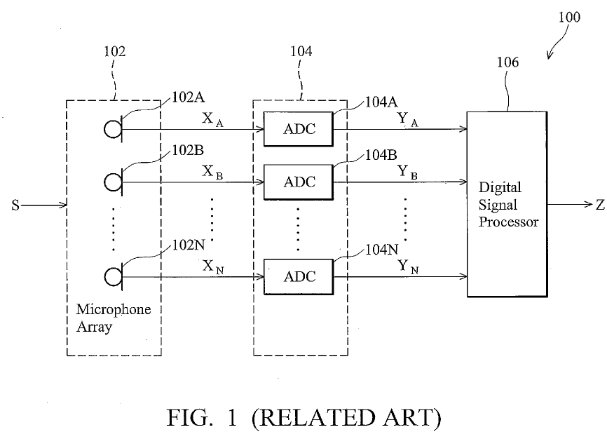

It can be seen in FIG. 4A that electret condenser microphones with higher shunt resistance have frequency responses with less phase shift. The microphone with 1 tera Ω shunt resistance has least phase shift, and the microphone with 10 G Ω shunt resistance has greatest phase shift. If the electret condenser microphone is a part of a microphone array as shown in FIG. 1, the phase shift of the low frequency response can negatively affect system performance. Because the DSP 106 derives the signal Z according to the small phase difference between the signals Y_{A}˜Y_{N}, if the phase difference between the signals Y_{A}˜Y_{N} comprises phase shift due to microphone, the signal Z may be erroneously generated.

Additionally, it can be seen in FIG. 4A that phase shift is greater especially for the input sound with low frequency, such as the frequency less than 1 kHz. Infrasonic microphones for detecting sounds with frequencies ranging from 10⁻³ Hz to 10² Hz, however, have important application in measuring earthquakes, nuclear explosions, and tornadoes at a distance of thousands of kilometers.

Thus, to reduce the phase shift generated by an electret condenser microphone, a shunt resistance is added to the electret condenser microphone. A method for adding the shunt resistance is to select a big preamplifier input resistance, such as a preamplifier input resistance of 100 GΩ. Additionally, because moisture affects the phase response of an electret condenser microphone, the electret condenser microphone must be protected from moisture.

(6) Variation of Microphone Capacitance:

Variation of microphone capacitance is influenced by mechanical properties of the diaphragm of the electret condenser microphone, especially for microphones having higher sensitivities. At low frequencies, the electromechanical coupling adds to the capacitance (by up to 15%) while it subtracts capacitance above the diaphragm resonance (1˜2%) where the phase of the diaphragm movements is opposite.

Because the input capacitance of the preamplifier coupled to the electret condenser microphone is generally low, the low input capacitance of the preamplifier reduces effects caused by variation of the microphone capacitance. Thus, small variation of microphone capacitance is generally ignored.

(7) Vent Sensitivity:

A vent of an electret condenser microphone enables the cavity inside the microphone to become a pressure equalization tube between outside air and internal cavity(formed by electret plate and diaphragm). The pressure inside an electret condenser microphone is kept constant by sealing the cavity of the microphone except for a small vent. The vent enables the cavity inside the microphone to become a pressure equalization tube with high acoustic impedance. Only the air of low frequency leaks into the vent, thus keeping the air pressure inside the microphone equal to the outside pressure so that the diaphragm of the electret condenser microphone does not bulge with the air pressure.

It is desirable for matched electret condenser microphones to have low vent sensitivity because they can then be pointed to any direction in a sound field without the vent influencing their phase response. A matched microphone pair then has a constant phase-response difference.

Since only sounds with low frequency enter the vent, the vent sensitivity of microphone pair is defined as how much sound enters the static-pressure equalization vent relative to the sound level at the microphone diaphragm. Typical vent sensitivity of electret condenser microphone is less than −60 dB at 20 Hz for matched microphones. To lower the vent sensitivity of electret condenser microphone, the vent is shrinked or removed.

(8) Low Frequency Phase Response:

Low frequency phase response of an electret condenser microphone is determined by the microphone capacitance Cₘ and the preamplifier input resistance Rᵢ, and high frequency phase response of an electret condenser microphone is determined by the output impedance of the preamplifier and the cable load. The −3 dB cut-off frequency is given by the following formula:

$${f}_{- 3} = \frac{1}{2 π \cdot {R}_{i} \cdot {C}_{m}}$$

To lower the electrical cut-off frequency of an electret condenser microphone, a stray input capacitance of about 80 pF is added to a preamplifier of the electret condenser microphone. Thus, the electret condenser microphone can detect sounds with low frequency.

(9) Polarization Voltage:

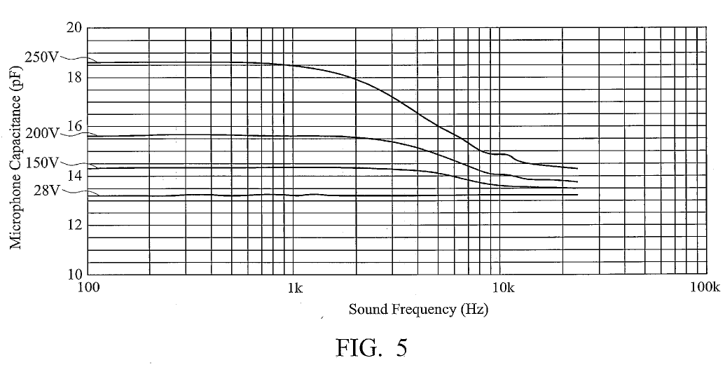

A polarization voltage is a high voltage polarizing the dielectric media forming a portion of a diaphragm or a back plate of an electret condenser microphone. The microphone capacitance and its variation with frequency is a function of a polarization voltage. FIG. 5 shows a relation between microphone capacitances corresponding to four polarization voltages and sound frequency. The four polarization voltages are 28V, 150V, 200V, and 250V, and higher polarization voltage generates electrert condenser microphones with higher capacitance.

If the polarization voltage has great error, the resulted error of the microphone capacitance correspondingly induces great phase variation of the electret condenser microphone. To reduce phase variation of the electret condenser microphone, the error of the polarization voltage for fabricating the electret condenser microphone must be controlled to a small range.

(10) Vent Position:

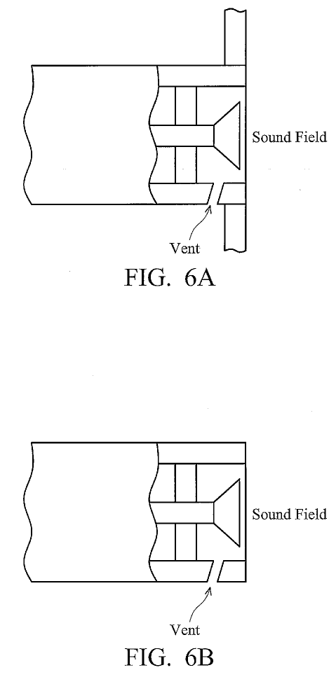

The low frequency response of an electret condenser microphone is greatly affected by the position of the external vent opening. The vent opening may be isolated from the outside sound field, as shown in FIG. 6a. Otherwise, the vent opening may be exposed to the outside sound field, as shown in FIG. 6b. The phase response of an electret condenser microphone is different in the two cases.

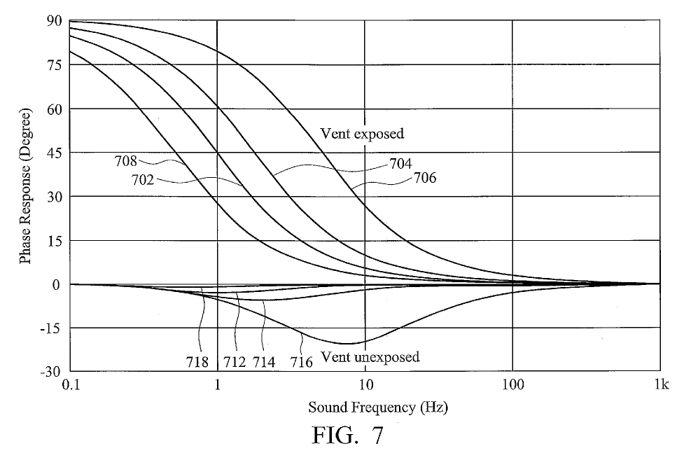

Static pressure equalization channels can be rear vented or side vented. Vent unexposed microphones, having a vent excavated through the rear of the microphone, thus leading the vent to the cavity holding the preamplifier, thus referred as to rear vented channel. The vent exposed microphone, has a vent located on the side of the microphone capsule, thus referred as to side vented channel. FIG. 7 shows the phase response of electret condenser microphones with exposed vent and unexposed vent. Lines 702, 704, 706, and 708 indicate phase responses of electret condenser microphones with exposed vent respectively under the ambient pressures of 1 bar, 2 bar, 10 bar, and 0.5 bar. Lines 712, 714, 716, and 718 indicate phase responses of electret condenser microphones with unexposed vent respectively under the ambient pressures of 1 bar, 2 bar, 10 bar, and 0.5 bar.

It can be seen in FIG. 7 that the electret condenser microphone with an unexposed vent has lower phase shift. Thus, to reduce the phase variation of an electret condenser microphone, the vent of the electret condenser microphone is selected as an unexposed vent.

The invention provides a method for reducing phase variation of signals generated by an electret condenser microphone. Ten consideration factors for designing the electret condenser microphone are provided. The phase match of suitable electret condenser microphones are thus improved and performance of microphone array comprising the electret condenser microphones is also improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for reducing phase variation of a signal generated by an electret condenser microphone, comprising:
reducing an error of a capacitance of the electret condenser microphone;
increasing an impedance of the electret condenser microphone;
adding a shunt resistance to the electret condenser microphone; and
lowering a −3 dB cut-off frequency of the electret condenser microphone.

2. The method as claimed in claim 1, wherein the method further comprises reducing an error of a capacitance of a preamplifier coupled to the electret condenser microphone.

3. The method as claimed in claim 1, wherein the error of the capacitance of the electret condenser microphone is reduced to between −1% and 1%.

4. The method as claimed in claim 1, wherein increase of the impedance of the electret condenser microphone comprises reducing the capacitance of the electret condenser microphone, wherein reduction of the capacitance of the electret condenser microphone comprises increasing a thickness of a spacer of the electret condenser microphone.

5. The method as claimed in claim 1, wherein the addition of the shunt resistance comprises increasing an input resistance of a preamplifier coupled to the electret condenser microphone.

6. The method as claimed in claim 1, wherein reduction of error of the capacitance of the electret condenser microphone comprises decreasing an input capacitance of a preamplifier coupled to the electret condenser microphone.

7. The method as claimed in claim 1, wherein lowering the −3 dB cut-off frequency of the electret condenser microphone comprises adding a stray input capacitance of a preamplifier coupled to the electret condenser microphone, wherein the stray input capacitance of the preamplifier is about 80 pF.

8. The method as claimed in claim 1, wherein the method further comprises reducing an error of a polarization voltage used in fabrication of the electret condenser microphone.

9. A method for reducing phase variation of a signal generated by an electret condenser microphone, comprising:
reducing an error of a thickness of a spacer of the electret condenser microphone;
reducing phase asymmetry of the signal while the electret condenser microphone rotates about a central axis thereof;
reducing a sound sensitivity of a vent of the electret condenser microphone;
and
preventing the vent of the electret condenser microphone from being exposed to an outer sound field.

10. The method as claimed in claim 9, wherein reduction an error of the thickness of the spacer comprises increasing the thickness of the spacer, wherein the thickness of the spacer is increased to 40 μm.

11. The method as claimed in claim 9, wherein reduction of the phase asymmetry comprises improving a parallel level between a diaphragm and a back plate of the electret condenser microphone, wherein improvement of the parallel level between the diaphragm and the back plate comprises increasing a thickness of a spacer of the electret condenser microphone.

12. The method as claimed in claim 9, wherein reduction of the sound sensitivity of the vent comprises shrinking the size of the vent or removing the vent.

13. The method as claimed in claim 9, wherein prevention of exposure of the vent comprises excavating the vent through the rear of the electret condenser microphone, thus leading the vent to the cavity holding an IC of a preamplifier coupled to the electret condenser microphone.

14. The method as claimed in claim 9, wherein the method further comprises reducing an error of a polarization voltage used in fabrication of the electret condenser microphone.

15. An electret condenser microphone, comprising:
a microphone module, having a microphone capacitance with a low error and a high microphone impedance; and
a preamplifier module, coupled to the microphone module, having a preamplifier capacitance with a low error and a high input resistance;
wherein the electret condenser microphone has a low −3 dB cut-off frequency.

16. The electret condenser microphone as claimed in claim 15, wherein the error of the microphone capacitance and the error of the preamplifier capacitance is between −1% and 1%.

17. The electret condenser microphone as claimed in claim 15, wherein the microphone capacitance is low, thus increasing the microphone impedance.

18. The electret condenser microphone as claimed in claim 15, wherein the microphone module has a spacer with a high thickness, thus reducing the microphone capacitance.

19. The electret condenser microphone as claimed in claim 15, wherein the preamplifier module has a stray input capacitance lowering the −3 dB cut-off frequency of the electret condenser microphone, wherein the stray input capacitance of the preamplifier module is about 80 pF.

20. An electret condenser microphone, comprising:
a capsule, having a vent unexposed to an outer sound field; and
a spacer, separating a diaphragm and a back plate, having a thickness with a low error;
wherein the vent has a low sound sensitivity.

21. The electret condenser microphone as claimed in claim 20, wherein the thickness of the spacer is high, thus reducing the error of the thickness of the spacer, wherein the thickness of the spacer is 40 μm.

22. The electret condenser microphone as claimed in claim 21, wherein the thickness of the spacer is high, thus improving a parallel level between the diaphragm and the back plate.

23. The electret condenser microphone as claimed in claim 21, wherein the vent has a small size or is removed to reduce the sound sensitivity thereof.
